(19) United States
(12) Patent Application Publication
(10) Pub. No.: US 2015/0331752 A1
(43) Pub. Date: Nov. 19, 2015

(54) METHOD OF DATA STORAGE ON CLOUD DATA CENTER FOR REDUCING PROCESSING AND STORAGE REQUIREMENTS BY ENGAGING USER EQUIPMENT

(71) Applicants: Syed Ali Haider, Rawalpindi (PK); Muhammad Umar Hameed, Bahawalpur (PK)

(72) Inventors: Syed Ali Haider, Rawalpindi (PK); Muhammad Umar Hameed, Bahawalpur (PK)

(21) Appl. No.: 14/280,160

(22) Filed: May 16, 2014

(51) Int. Cl. G06F 11/14; H04L 29/08

(52) U.S. Cl. CPC G06F 11/1412; H04L 67/10

(57) ABSTRACT

The invention relates to a method of storage of encoded blocks of files on user-equipment along with the datacenter. Files are coded on the user equipment and coded blocks are distributed among participating user end devices and the data center storage fabric. The storage of parts of file on the user equipment reduces the storage requirement at the data center and reconstruction at the user equipment releases the data center off the processing overhead. Similarly, North-South and East-West traffic is reduced since only a coded part of the file is transported to the data center unlike conventional data centers where entire files are stored on the data center. The invention reduces processing and storage overhead at the data center while reducing the amount of traffic generated for the data center.

### BACKGROUND OF THE INVENTION

Data centers maintain backups of files on their storage fabric in order to provide reliability in case of loss of data. Simple replication of files is inefficient therefore, a large number of data centers use erasure codes. Erasure codes encode files and generate parts of data and parity bits that represent the file such that if one of the blocks is lost, file can be reconstructed using fewer left over blocks. Various erasure coding techniques have been proposed in literature, some of which are used by major players such as Microsoft, Google, Facebook, Yahoo and IBM. Other techniques in the literature present various methods for coding and of improving coding efficiency.

In Sawhney et al., U.S. Pat. No. 8,370,312, the authors of the patent propose a technique that directs the client device to storage the storage object on multiple servers including a server other than the specific service provider. The data is stored away from the user end and at a third party location for redundancy. Technique proposed in this instant is different since we propose to involve the client side user equipment to store and reconstruct (local or otherwise) data there in the event of a loss.

Disk and rack failures are major failures in the cloud. It is also known that transient failures occur more occasionally than permanent failures. Transient failures include temporary disk removals, crashing or restarting of operating systems, or other such failures.

Systems achieve ideality if they are able to reconstruct a node by incorporating minimum overhead. The need for this efficiency becomes even more pronounced when increase in use of cloud storage services is taken into consideration. Not only are consumers moving their data to the cloud, organizations are also shifting towards using cloud-based storage and computing.

In order to cater to the high demand, erasure codes provide higher data storage efficiency compared to simple replication, the simplest way of securing information. Coding, unlike replication, essentially reduces overheads by storing the minimum amount of extra information required to reconstruct the data when required. When a coded block is lost, a reconstruction event is invoked and remaining coded blocks are gathered from various known locations. However, there is a delay, storage overhead and processing overhead along with increase in East-West traffic (between data center servers) for reconstruction.

In conventional storage systems, three replicas of data are made and distributed geographically across data centers. Replication used in most of the data centers incurs high storage cost and increases traffic.

On the other hand, erasure codes offer clear advantage, over simple replication, by using chunk formation—the process of creating multiple parts of a file including parity blocks. The codes define the tolerance—number of nodes that can go missing without hindering with the reconstruction process. A higher tolerance represents a better code.

Erasure coding attains the task of fault tolerance without replication and it introduces several complexities such as traffic I/O, processing, storage overheads and efficiency. Local reconstruction reduces the traffic by two folds and increases storage capacity by 14%. Irrespective of which technique is used, there is a tradeoff between storage and the bandwidth required to repair.

There is a need for next generation of cloud storage systems that address the high and ever increasing volumes of data being stored and accessed from the cloud and also reduce the burden on the Internet and the data centers while making the users the stakeholders in the process.

Since data centers store the entire file information on their storage fabric the user acts as a passive entity requesting and consuming information with no control over their data, hence creating skepticism about security and privacy. However, the excessive processing and storage at the user equipment can be used to the benefit of all. At the data center end, it reduces storage and processing requirement as well as reduces the traffic generated for files. At the user end it increases security by not having a complete file at any one device.

### BRIEF SUMMARY OF THE INVENTION

There is abundant idle processing power and storage at the user end and we propose to use the same for decreasing the burden on the datacenters. The coded blocks are saved on the user equipment along with the data center and the reconstruction occurs at the user end as well. This essentially saves processing, storage and traffic at the data center. Moreover, since a part of the file is saved at the data center and user equipment storage requirement at each one of them is reduced. When required, a file is either locally reconstructed using part on user equipment or using blocks from the data center depending on where the failure has occurred. Since the blocks are coded at the user equipment, only a part of the data is transported to the data center therefore reducing the amount of North-South traffic.

### BRIEF DESCRIPTION OF THE DRAWING

FIG. 1 depicts a system diagram. There are a number of user equipment 101(1)-101(N) connected with the cloud storage system 103 through a Packet Data Network (PDN) 104. Each user equipment 101 has storage 110 and some processing capability 112 along with a chunk/recovery manager 113. Local Storage 110 can be a hard disk drive, a variable storage capacity ranging from 100 GB to 2 TB (commercially available). 112 is a processor at the user equipment that comprises of a single or multiple cores. Multiple core processors may have 2, 4, 5, 6, 7, 8 and even 10 cores. Chunk/Recovery manager 113 creates chunks by using a coding scheme on a file before uploading a part on cloud. 113 also acts as the recovery manager and reconstructs the file if one of the parts is lost.

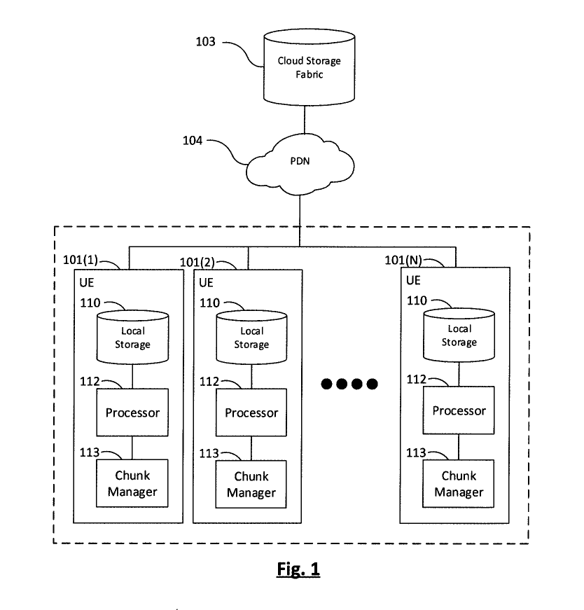

FIG. 2 depicts the method of uploading of a file on the cloud/user equipment while forming chunks through the chunk manager. There are two or more (in case of more than one user equipment) systems 1) at the cloud end i.e., cloud system 206 and 2) at user equipment 200. user equipment consists of local storage 202 and chunk manager 204. Request 208 is initiated from the user's local storage. The chunk manager receives the request 210 and requests for cloud connectivity/availability 212. Cloud system receives the request 214 and replies 220 to confirm connectivity/availability. The other Use receives part upload request 216 and responds with its availability status. Chunk formation and calculation of parity of the file 226 starts at the chunk manager. It distributes the chunks 232, stores the chunk and parity of the file on the user equipment's local storage 230 along with the log 236 and other chunks of the file at the cloud along with the log 238. Chunk Manager also sends a part of the file to the other available user equipment 240. Log of the chunks 236 contains information about coding scheme used and the location of parts for later during reconstruction.

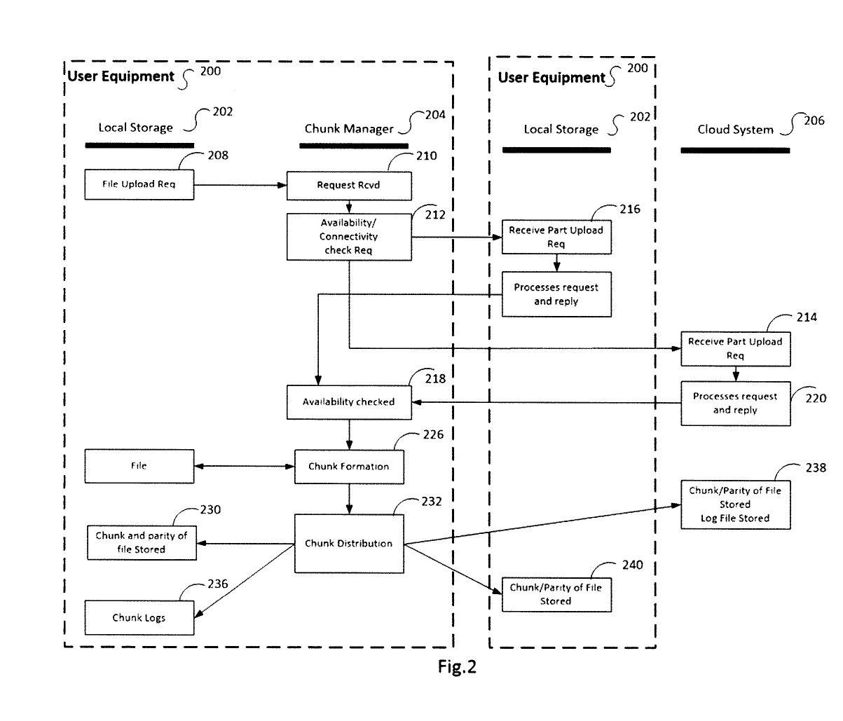

FIG. 3 depicts the reconstruction process from local storage and cloud. Chunks and parity of the particular file reside on the local storage and on the cloud. The process starts with a file access request that is received at the Recovery Manager at 310. The recovery manager initializes for reconstruction at 312 and lodges a formal file formation request 314. The recovery manager then locates the log file that has information about the chunks and parity at 316 and sends out requests for chunks to be retrieved 322. The cloud system and the participating user equipment receives the chunk request at 318 and transfer the chunk to the recovery manager 320. After receiving all the required chunks the recovery manager reconstructs the file 322 and re-distributed the chunks at 324. Chunks are received and stored at the cloud and the user equipment at 326. Following this log file is updated at 328.

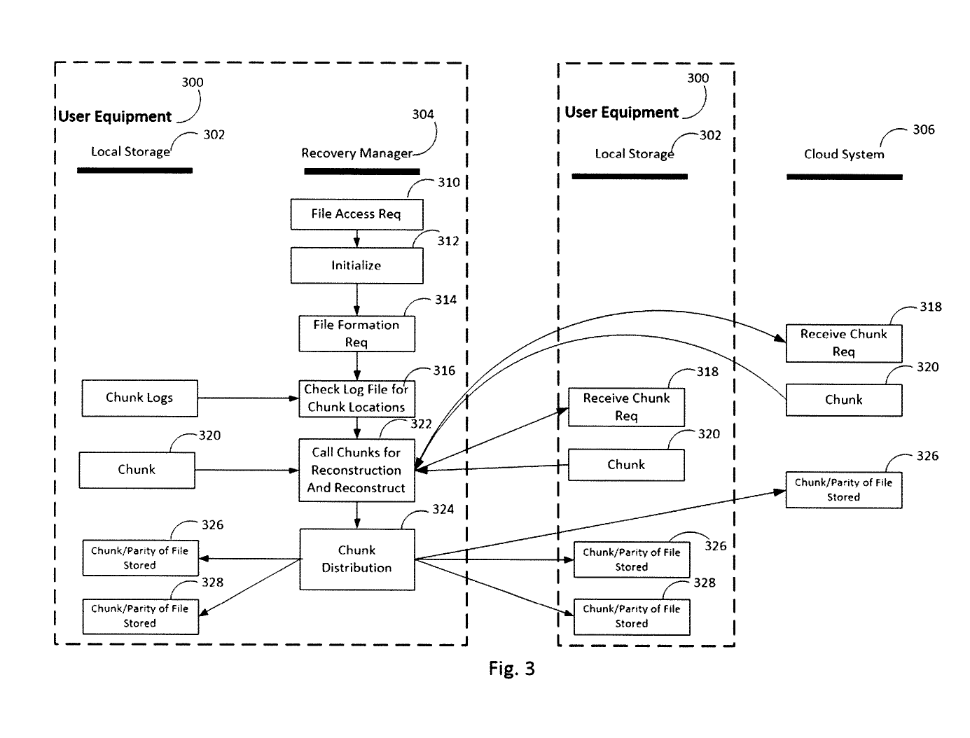

### DETAILED DESCRIPTION OF THE INVENTION

Cloud storage is seeing immense growth both in the corporate and consumer worlds. Individuals as well as corporate users are moving towards the cloud for ubiquitous access of data, computation and virtualization. There are two major setbacks that increasing the use of cloud storage creates. (1) The cloud is not secure and even if it is, the consumers fear their data will be compromised. This is one of the reasons why corporations are hesitant to move to the cloud and to leave local storage behind, for good. (2) The ever-increasing use of cloud is directly or indirectly increasing the amount of North-South and well as East-West traffic. Cloud data centers currently store data on the cloud servers with redundant files also stored on the cloud servers.

The proposed technique saves the cloud data centers three of the most important resources i.e., storage, processing and bandwidth (both East-West and North-South).

Offloading of processing and some of the data eases the data-centers, increases utilization of the user equipment, reduces North-South/East-West traffic, and ensures security by virtue of by-part storage of data at the data-center and the user equipment. Distributed redundancy coding is used to generate redundant parts of the data file, which is pushed to the cloud by the respective user equipment after local processing. The data-file, when required, is locally reconstructed for the user and when changed, is distributed as parts among user equipment and the data center.

Distributed parts, as well as security due to local storage, ensure consumer satisfaction. For complete reconstruction only the cloud part is not sufficient. One of the main properties of cloud is its reliability.

Overhead can be reduced significantly by migrating the data/parity blocks outside the datacenter, to the user equipment (user equipment). Data is partitioned into data blocks and encoded parity blocks. In a (n, k) code there are n data nodes and k parity nodes with a tolerance of n-k failed nodes. Parity nodes are used to reconstruct the failed nodes.

A user equipment based entity called recovery manager, is responsible for all the k chunks of n data; distribution of chunks; location of chunks and recovery of failed nodes. The recovery manager selects the parity nodes from user equipment and the cloud, monitors reconstruction. From within the user equipment, the recovery manager is placed at the device that offers the most available processing power.

Once a file is stored in a specific folder in the system the Chunk Manager starts creating parts of the data file and calculates the parity bits for the entire file. Parity bits along with data bits, in the form of blocks of data, are initially stored at the user equipment running the Chunk Manager. Once the parts are successfully created and stored at the user equipment, they are distributed to participating devices at the user end and the cloud data center. A log file is created that contains the location of all parts for the particular file. Log file is saved at user equipment and the data center. After the process of saving a new file completes, ideally, a part(s) of the file is stored at the data center and other part(s) at the participated user equipment. The saving in North-South traffic is achieved by only transporting a part of the file to the data center instead of the entire file.

There can be a few recovery scenarios depending on which device has failed. When a user equipment (containing parts of files) fails, the recovery manager is invoked that initiates the recovery process. Recovery is done by first finding out the lowest link rate among all the locations that have a part of the file stored. This is the link rate that is used for the entire recovery process by the recovery manager. The recovery manager manages the reconstruction. When a data center server that contains part of the file fails, the recovery manager performs a local reconstruction of data. In local reconstruction only the file parts residing on the user equipment are used for reconstruction. The lowest link rate available is used at the link rate for reconstruction. The recovery manager manages the reconstruction.

When a device that has the recovery manager fails, data center performs the role of recovery manager. Using the log file stored at the time of file storage. The lowest link rate is used for reconstruction. The data center manages the reconstruction.

Processors with clock speed of 1 GHz are common in user end devices with dual- and quad core processors available in many devices as well. These devices include smartphones, tablets and desktop computers.

1. A method of storage and retrieving of coded electronic files comprising:
breaking up the coded electronic files into first set of coded electronic files and showing the first set in a cloud database and a second set of coded electronic files, storing the second set on a user's equipment; and,
retrieving the coded electronic file on the user equipment by combining the first set and the second set to reconstruct the coded electronic files.

2. The method according to claim 1, further comprising:
processing of reconstruction at the user equipment such that only a part of the coded file is uploaded to the data center and retrieved during reconstruction if blocks of data are lost at user equipment and local reconstruction is not a possibility.
